(19) United States
(12) Patent Application Publication
(10) Pub. No.: US 2004/0133822 A1
(43) Pub. Date: Jul. 8, 2004

(54) Program development support method

(76) Inventors: Jun Yoshida, Kawasaki (JP); Tetsuya Hashimoto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/608,208

(22) Filed: Jun. 30, 2003

(30) Foreign Application Priority Data
Dec. 2, 2002 (JP) 2002-349355

(51) Int. Cl. G06F 9/44

(52) U.S. Cl. 714/38; 717/113

(57) ABSTRACT

To create a screen and a calling program for each service component, and a screen sequencing program when a system for allowing an application developer to make confirmation through a dialogue with a screen as to how to select a combination of existing service components, each work and input/output data thereof are defined, correspondence of each work to service components available in the work is defined, and a flow among the works is defined. Based on such definitions, an input screen and an output screen are created for each work, and flow definition information of the works is converted into flow definition information of screens so as to create a screen sequencing program. The program is executed through a dialogue with the application developer in accordance with an input operation of the application developer. A system for allowing the developer to make confirmation through a dialogue is produced.

### BACKGROUND OF THE INVENTION

The present invention relates to a mechanism for an application developer to make confirmation through a dialogue with a screen as to how to select a combination of existing service components.

U. Wahli, et al., “Web Services Wizardry with WebSphere Studio Application Development (2002)”, p.354-357, IBM Redbooks, April 2002, discloses a mechanism for automatically creating a sample screen out of a single service component so that the service component can be called through the sample screen.

In recent system development, existing distributed program components are often purchased and combined to develop an application in order to develop the application in a short time and at a low cost correspondingly to the speed of change in business. By use of existing program components, the number of man-hours for application development is reduced so that the productivity can be improved. Here, a program using such program components will be referred to as “client program”.

Each program component is produced in accordance with fixed rules such as an interface definition method, a procedure for use from a client, a procedure for communication, and the like. A service component is a form of program component, which can be reused by purchasing a right of access to a program produced in accordance with fixed rules and disclosed on a network such as the Internet, and calling the service component from an application. That is, a service component provider manages a service component while a client merely uses the service component.

In an application, optimum components have to be selected from a large number of available distributed program components on the basis of their function, performance, reliability, maintainability, price, and so on. However, in the case of a service component, it is difficult to change the interface definition thereof because a plurality of users shares the service. In addition, since the service component itself is managed by a service component provider, it may be impossible to respond to a request for improvement of performance or enhancement of reliability from the application side.

Therefore, if it is not verified in an upstream step of application development in advance whether correct connection with a service component to be used can be established or whether the response performance or reliability of the service component satisfies requirements, critical redo may be caused in a downstream step. Particularly, even if there is a problem in the performance or reliability of a service component, the system configuration of an application cannot be changed easily. Thus, the problem cannot be solved without a solution such as urging the service component provider to improve the service component, modifying the program to use another service, recasting the processing carried out by the service component itself from the ground up, or the like. Thus, use of a service component may lead to increase of a risk in application development.

In addition, when an application is developed, there is a case that a service component is not used alone, but service components are used in combination. For example, take up an application for investigating the price of a commodity through a price search service, ordering the commodity through an order service if the price thereof is within the budget, and searching another similar commodity through a similar commodity search service if the price of the commodity is beyond the budget.

As service components for implementing such works, assume that a search service provided by company A or B implements the price search service, a purchase service provided by company C implements the order service, and a search service provided by company D implements the similar commodity search service.

When there are a plurality of similar service components for one work such as the price search service, it is necessary to judge which service component is the best. Further, when a plurality of different kinds of service components are combined in accordance with the flow of works such as the flow from the price search service to the order service or the similar commodity search service, it is necessary to judge which service components are best combined with each other from the point of overall view.

It is, however, difficult to perform such judgement in advance without visual confirmation means such as a screen because services components have to be called from a program.

### SUMMARY OF THE INVENTION

In order to evaluate a combination of service components, assume that an input screen for executing a service component and an output screen for displaying the result thereof are created. In such a case, it is necessary to create input screens, output screens and client programs for calling service components, each as many as the service components. It is also necessary to create a screen sequencing program for sequencing the screens in accordance with the flow of works. When the screens are sequenced, it is also necessary to create a program for delivering data output from each screen to the following screen. Such a set of programs have to be added, deleted or corrected whenever any service component to be evaluated is changed.

It is an object of the present invention to enable an application developer to confirm a combination of service components through a dialogue with a screen in accordance with the flow of works.

In order to attain the foregoing object, according to the invention, when each work and input/output data thereof are defined, correspondence of each work to service components available in the work is defined and a flow among the works is defined, flow definition information of the works is thus converted into flow definition information of screens, and an input screen and an output screen are created for each work, so as to create a screen sequencing program. The screen sequencing program is executed dialogically through an input operation of the application developer.

### BRIEF DESCRIPTION OF THE DRAWINGS

FIG. 1 shows the outline of processing;

FIG. 2 is a configuration diagram of a service selection server;

FIG. 3 is a configuration diagram of a service component providing server;

FIG. 4 shows the relationship between definition information and definition tools;

FIG. 5 shows the details of the definition information;

FIG. 6 shows the details of a screen;

FIG. 7 shows the flow of processing for creating screen flow definition information;

FIG. 8 shows the flow of processing for creating a screen;

FIG. 9 shows a shared data storage portion; and

FIG. 10 shows the flow of processing for runtime environment.

### DESCRIPTION OF THE EMBODIMENTS

An embodiment of the present invention will be described with reference to the drawings.

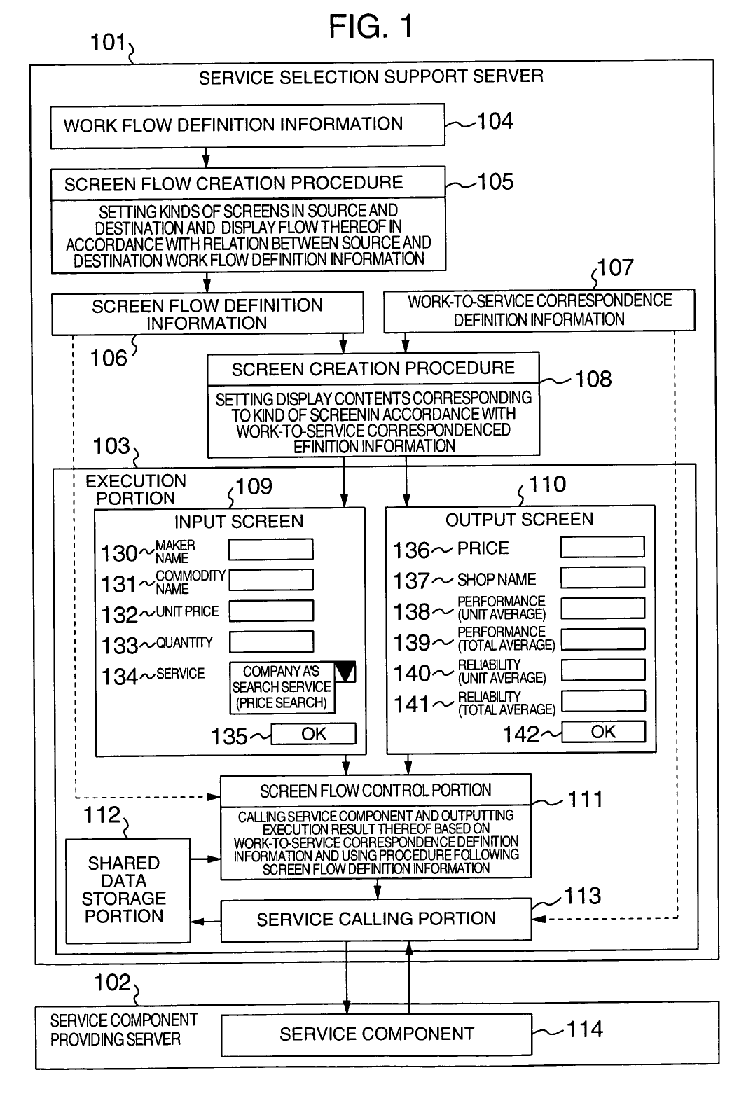

FIG. 1 shows a system group chiefly constituted by a service selection support server 101 for evaluating a combination of service components, and a service component providing server 102. In this embodiment, screens (web pages) or screen (web page) flow definition information is created from various kinds of definition information in the service selection support server 101 so that the combination of service components can be evaluated in an execution portion 103.

To create the screen flow definition information, a screen flow creation procedure 105 establishes the kind of source screen and the kind of destination screen for each work (activity) in work flow definition information 104 indicating a flow among the works, and the display flow of the screens, so as to create screen flow definition information 106 indicating the flow of screens. This creation is carried out in the following method.

(1) Each line of the work flow definition information 104 is read. For each source work 115, a line having the input screen of the source work 115, the source work 115 and the output screen of the source work 115 correspondingly to a source screen 117, a work 118 and a destination screen 119 respectively is added to the screen flow definition information 106.

(2) When the next line of the work flow definition information 104 designates the same source work 115, a line having the output screen of the source work 115 and a branch selection screen correspondingly to the source screen 117 and the destination screen 119 respectively and a line having a branch selection screen and an input screen of a destination work 116 correspondingly to the source screen 117 and the destination screen 119 respectively are added.

(3) When the next line of the work flow definition information 104 does not designate the same source work, a line having the output screen of the source work 115 and an input screen of the destination work 116 correspondingly to the source screen 117 and the destination screen 119 respectively is added. Thus, the screen flow definition information 106 is created.

Next, in a screen creation procedure 108 for creating a screen, an input screen 109, an output screen 110 or the like, for executing a service component corresponding to each work and for allowing an application developer to evaluate the service component is created on the basis of the screen flow definition information 106 and work-to-service correspondence definition information 107 indicating the correspondence of each work to each service component. This creation is carried out in the following method.

(1) Each line of the screen flow definition information 106 is read. When the source screen 117 is the input screen 109, names of input data and text fields thereof are added to the input screen 109 on the basis of the work-to-service correspondence definition information 107.

(2) When there are a plurality of corresponding service components, a combo box for selecting a service component name is added, and a button for executing a request is added to the screen.

(3) When the source screen 117 is a branch selection screen, buttons for moving to the destination screen 119 are added to the screen.

(4) When the destination screen 119 is an output screen, names of output data and text fields thereof are added to the output screen 110 and text fields for displaying performance evaluation results or reliability evaluation results are added thereto on the basis of the work-to-service correspondence definition information 107, while a button for moving to the next screen is added to the screen.

By course of the aforementioned procedure, evaluation can be started in the execution portion 103.

First, the application developer inputs information on the input screen 109 and transmits a request to a screen flow control portion 111. Thus, evaluation in the execution portion 103 is started to perform the following processings.

(1) The screen flow control portion 111 accepts the request and calls a service calling portion 113.

(2) The service calling portion 113 calls a service component 114 defined by the work-to-service correspondence definition information 107 in accordance with an instruction.

(3) The service calling portion 113 stores a result of execution into a shared data storage portion 112.

(4) The screen flow control portion 111 embeds the result of execution into the output screen 110 defined by the screen flow definition information 106, and displays the result of execution to the client.

That is, in the execution portion 103, calling each service component and outputting a result of evaluation thereof are carried out using the input and output screens based on the work-to-service correspondence definition information in the procedure complying with the screen flow definition information. Thus, the combination of service components is verified.

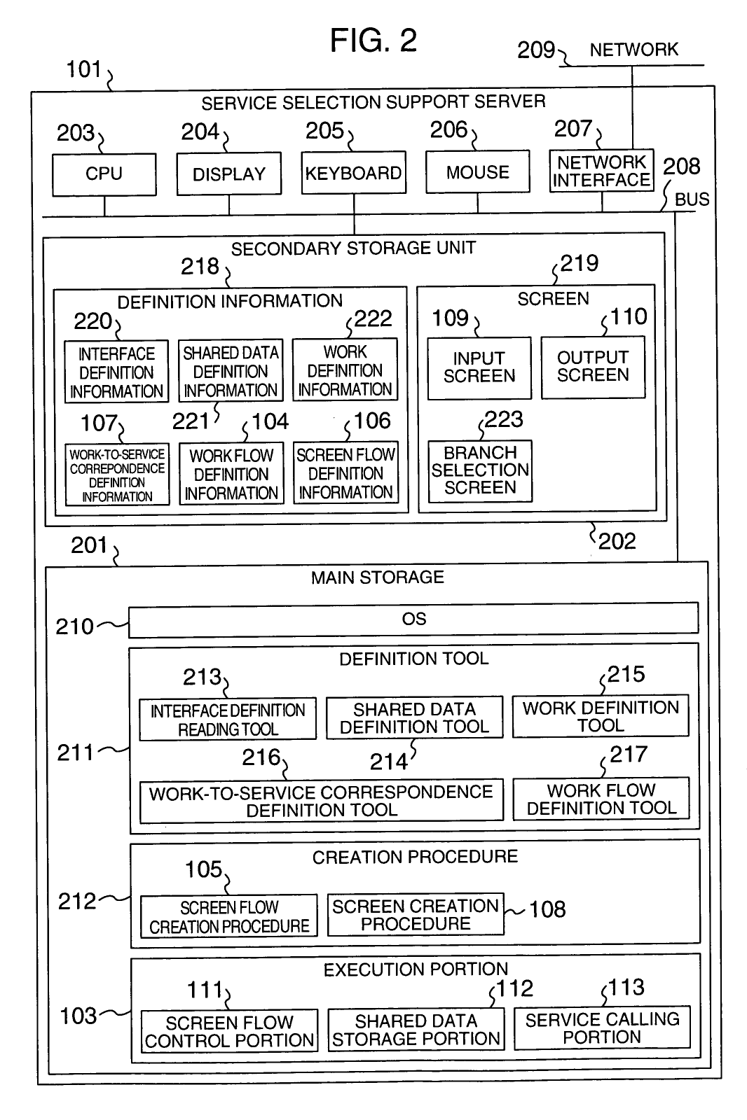

FIG. 2 shows a configuration diagram of the service selection support server 101. The service selection support server 101 is constituted by a main storage 201, a secondary storage unit 202, a CPU 203, a display 204, a keyboard 205, a mouse 206, a network interface 207, and a bus 208 connecting the constituent members 201 to 207 with one another. Then, the service selection support server 101 is connected to a network 209 through the network interface 207.

In addition, an operating system (hereinafter referred to as “OS”) 210, a definition tool 211, a creation procedure 212 and the execution portion 103 for executing the method according to the present invention are stored in the main storage 201. Further, definition information 218 and a screen 219 are stored in the secondary storage unit 202. The program for executing the method according to the present invention may be stored in a computer-readable storage medium so as to be read therefrom into the main storage 201 and executed.

The definition tool 211 is a tool for creating the work flow definition information 104 and the work-to-service correspondence definition information 107 which will be inputs in the present invention. The definition tool 211 is constituted by an interface definition reading tool 213, a shared data definition tool 214, a work definition tool 215, a work-to-service correspondence definition tool 216 and a work flow definition tool 217. The interface definition reading tool 213 reads the interface definition information 220 of each service component 114 in accordance with an instruction of the application developer. The shared data definition tool 214 creates shared data definition information 221. The work definition tool 215 receives the shared data definition information 221 and creates work definition information 222 in accordance with an instruction of the application developer. The work-to-service correspondence definition tool 216 receives the interface definition information 220 and the work definition information 222 and creates the work-to-service correspondence definition information 107 in accordance with an instruction of the application developer. The work flow definition tool 217 receives the work definition information 222 and creates the work flow definition information in accordance with an instruction of the application developer.

The creation procedure 212 is constituted by the screen flow creation procedure 105 and the screen creation procedure 108. The screen flow creation procedure 105 receives the work flow definition information 104 and creates the screen flow definition information 106. The screen creation procedure 108 receives the work-to-service correspondence definition information 107 and the screen flow definition information 106 and creates the screen 219.

The execution portion 103 is constituted by the screen flow control portion 111, the shared data storage portion 112 and the service calling portion 113. In accordance with an instruction through the input screen 109, the screen flow control portion 111 calls the service calling portion 113, stores the execution result into the shared data storage portion 112, and displays the execution result on the output screen 110 defined by the screen flow definition information 106. The shared data storage portion 112 stores the execution result of the service calling portion 113 in order to share data among screens. In accordance with an instruction from the screen flow control portion 111, the service calling portion 113 calls a service component defined by the work-to-service correspondence definition information 107.

The definition information 218 is constituted by the interface definition information 220, the shared data definition information 221, the work definition information 222, the work-to-service correspondence definition information 107, the work flow definition information 104 and the screen flow definition information 106. The screen 219 is constituted by the input screen 109, the output screen 110 and a branch selection screen 223.

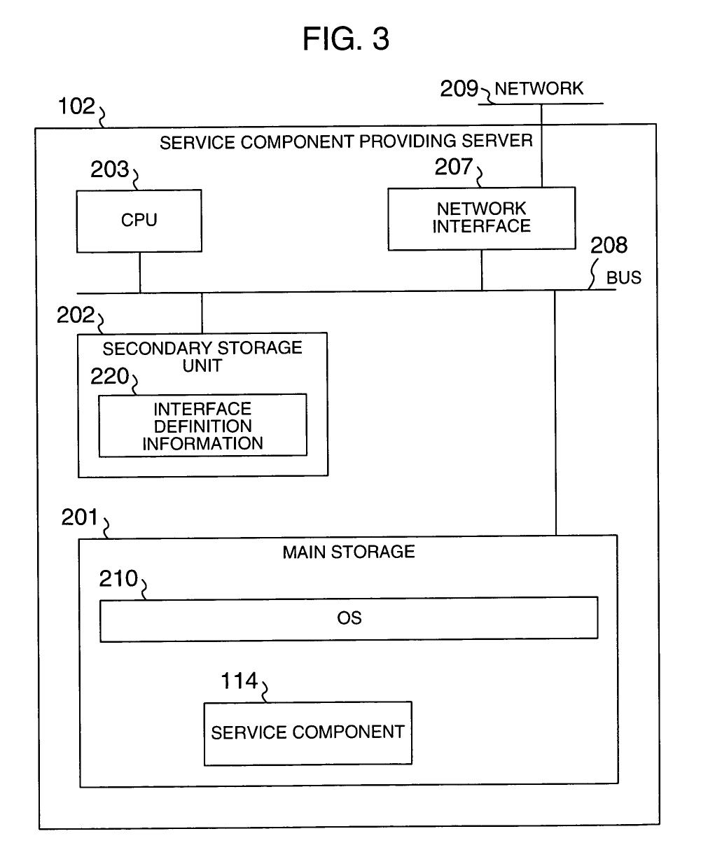

FIG. 3 shows a configuration diagram of the service component providing server 102. The service component providing server 102 is constituted by a main storage 201, a secondary storage unit 202, a CPU 203, a network interface 207, and a bus 208 connecting the constituent members 201, 202, 203 and 207 with one another. Then, the service component providing server 102 is connected to the network 209 through the network interface 207. That is, the service component providing server 102 is connected to the service selection support server 101 through the network 209.

In addition, an OS 210 and service components 114 are stored in the main storage 201. Further, interface definition information 220 is stored in the secondary storage unit 202.

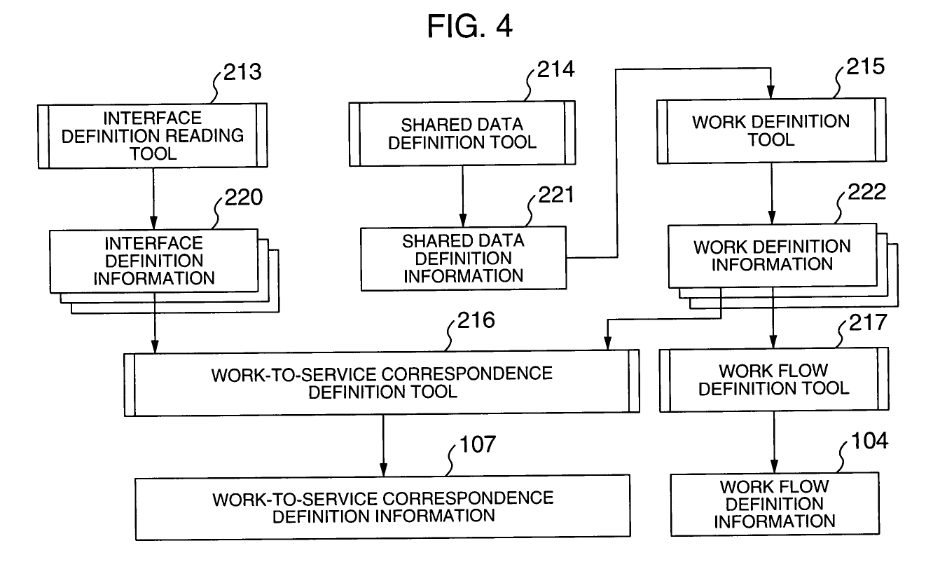

Next, the relationship between each definition information and each tool will be described with reference to FIG. 4.

First, the application developer uses the interface definition reading tool 213 to read the interface definition information 220 from an external server such as the service component providing server 102. The interface definition information 220 is information defining the interface for each service component 114. Next, the shared data definition information 221 which is information of data to be shared among screens is created by use of the shared data definition tool 214. Next, the work definition tool 215 receives the shared data definition information 221 and creates the work definition information 222 which indicates the contents of each work of the application. Next, the work-to-service correspondence definition tool 216 receives the interface definition information 220 and the work definition information 222 and creates the work-to-service correspondence definition information 107 which indicates the correspondence of each work to each service component. Next, the work flow definition tool 217 receives the work definition information 222 and creates the work flow definition information which indicates the flow of works.

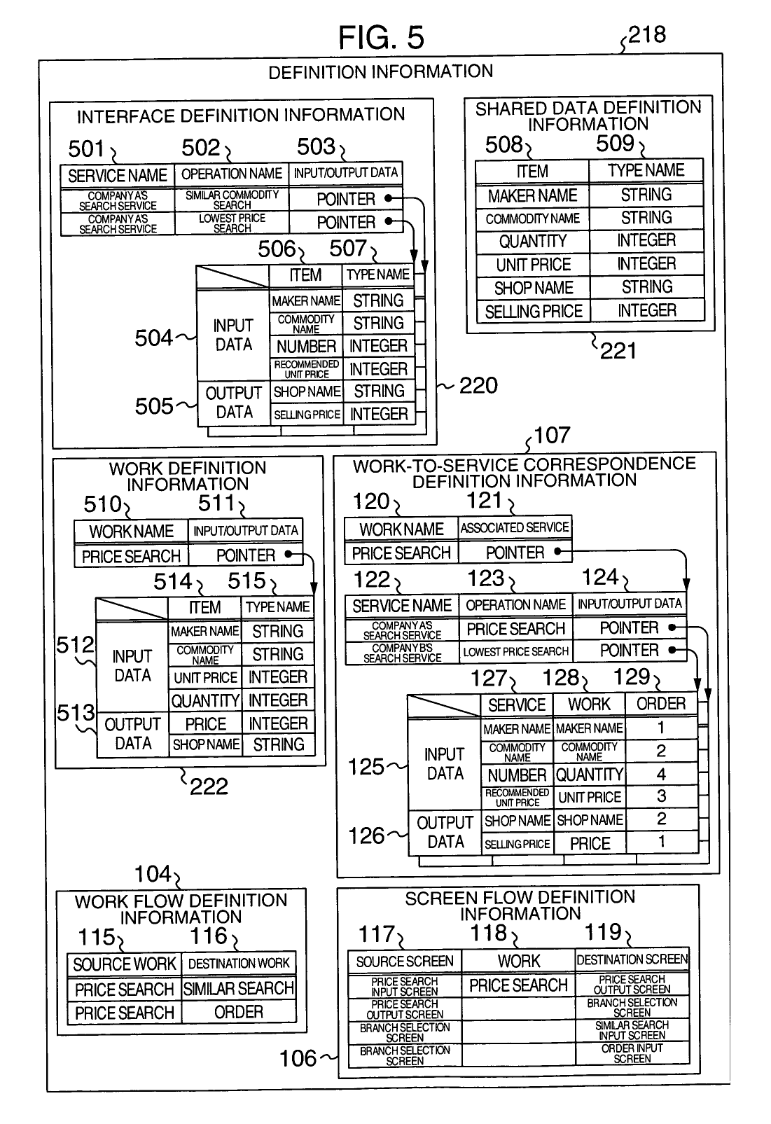

Next, each definition information, each screen, and so on, will be described in detail. FIG. 5 shows the details of the definition information 218. The definition information 218 includes the interface definition information 220, the shared data definition information 221, the work definition information 222, the work-to-service correspondence definition information 107, the work flow definition information 104 and the screen flow definition information 106.

The interface definition information 220 indicates the interface specifications of each service component 114. The interface definition information 220 is constituted by a service name 501 indicating the name of the service component, an operation name 502 indicating the name of an operation with which the service component is provided for a client, and input/output data 503 indicating the contents of input/output data for the operation. The input/output data 503 is constituted by input data 504 and output data 505. Each of the input data 504 and the output data 505 is constituted by an item 506 indicating the name of each data and a type name 507 indicating the type of the data.

The shared data definition information 221 indicates a set of data available to be shared among works. The shared data definition information 221 is constituted by an item 508 indicating the name of each data and a type name 509 indicating the type of the data.

The work definition information 222 indicates information of input/output data in each work. The work definition information 222 is constituted by a work name 510 indicating the name of each work, and input/output data 511 indicating the contents of input/output data. The input/output data 511 is constituted by input data 512 and output data 513. Each of the input data 512 and the output data 513 is constituted by an item 514 indicating the name of each data and a type name 515 indicating the type of the data.

The work-to-service correspondence definition information 107 indicates the correspondence of each work to each service component. The work-to-service correspondence definition information 107 is constituted by a work name 120 indicating the name of each work, and an associated service 121 indicating the contents of a service associated with the work. The associated service 121 is constituted by a service name 122 indicating the name of the service, an operation name 123 indicating the name of an operation associated with the work and input/output data 124 indicating the contents of input/output data for the operation. The input/output data 124 is constituted by input data 125 and output data 126. Each of the input data 125 and the output data 126 is constituted by a service 127 indicating the name of each data defined by the service component, a work 128 indicating the name of data defined by the work, and an order 129 indicating the definition order of the work 128 in the work definition information 222.

The work flow definition information 104 indicates the flow of works. The work flow definition information 104 is constituted by a source work 115 indicating each source in the flow, and a destination work 116 indicating each destination in the flow. When, of the respective lines of the work flow definition information 104, some lines have the same source work 115 and different destination works 116, one of the destination works 116 is determined in accordance with the result of work processing. This is called “branch”.

The screen flow definition information 106 indicates the flow of screens to which the flow of works has been converted by the screen flow creation procedure 105. The screen flow definition information 106 is constituted by a source screen 117 indicating each source in the flow, a work 118 indicating a work to be executed when the screen is moved from a source screen to a destination screen, and a destination screen 119 indicating a destination in the flow. The work 118 may be blank. When the work 118 is blank, the screen is moved from the source screen 117 to the destination screen 119 simply.

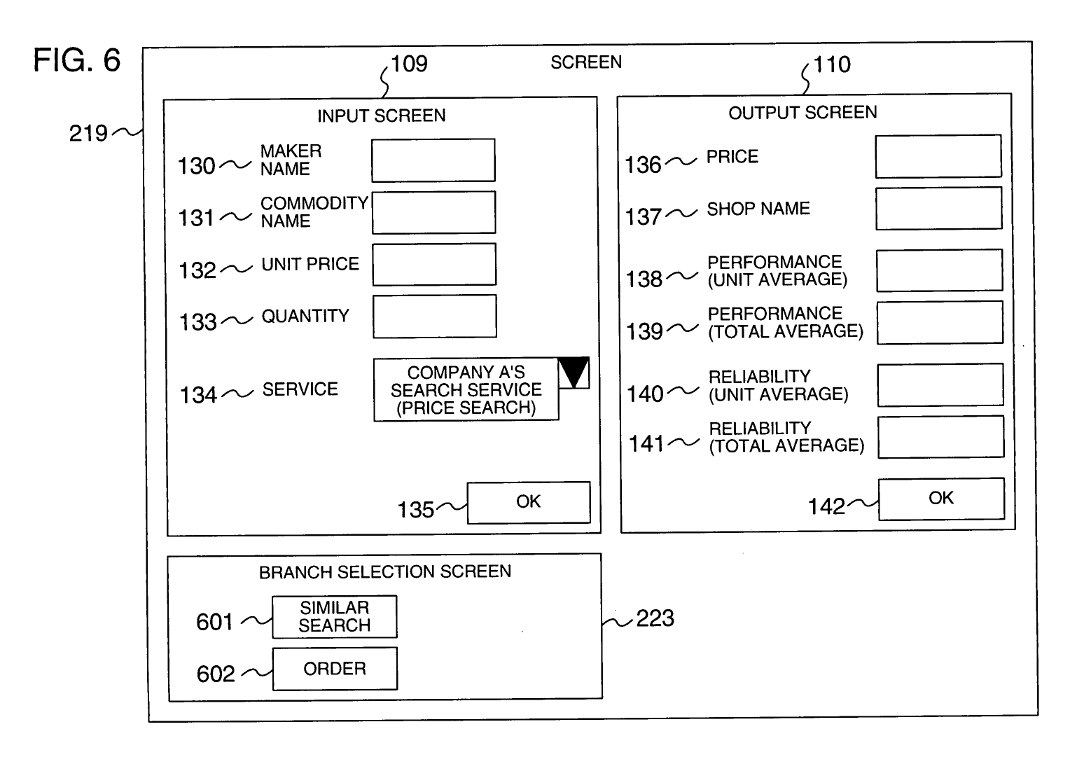

FIG. 6 shows the details of the screen 219 in FIG. 2.

The input screen 109 shows a screen for issuing an execution request for a service component 114 corresponding to a work. The input screen 109 is constituted by names of input data such as a maker name 130, a commodity name 131, a unit price 132 and a quantity 133, text fields for inputting the data, a service 134 which is a combo box for selecting a service associated with the work, and an OK button 135 for executing the request. Incidentally, previous data is displayed in each text field for input data only when the screen uses the same items as those of input/output data used for a work executed previously. Such display is adopted to confirm whether data can be delivered between works or not.

The output screen 110 shows a screen for displaying the execution result of a service component. The output screen 110 is constituted by names of output data such as a price 136 and a shop name 137, text fields for displaying the data, a performance (unit average) 138 and a performance (total average) 139 for displaying the performance result, a reliability (unit average) 140 and a reliability (total average) 141 for displaying the reliability, and an OK button 142 for giving an instruction to move to the next screen. The performance (unit average) 138 is obtained by measuring the time required for executing the service component alone and calculating an average value using the measured time together with the time measured on the same service component in the past. The performance (total average) 139 is obtained by summing up average values of times required for executing respective service components in accordance with the flow of works so as to calculate the total sum. The reliability (unit average) 140 is obtained as follows. It is judged whether a correct result is returned or not when the service component alone is executed. The value of 1 is set when a correct result is returned, and the value of 0 is set when an error is returned. The average value of values obtained thus is calculated as the reliability (unit average) 140. The reliability (total average) 141 is obtained by summing up average values of reliabilities of the respective service components executed in accordance with the flow of works so as to calculate the total sum.

The branch selection screen 223 shows a screen created when there is a branch in the work flow definition information 104. The branch selection screen 223 is constituted by buttons indicating the names of next works such as a similar search 601 and an order 602.

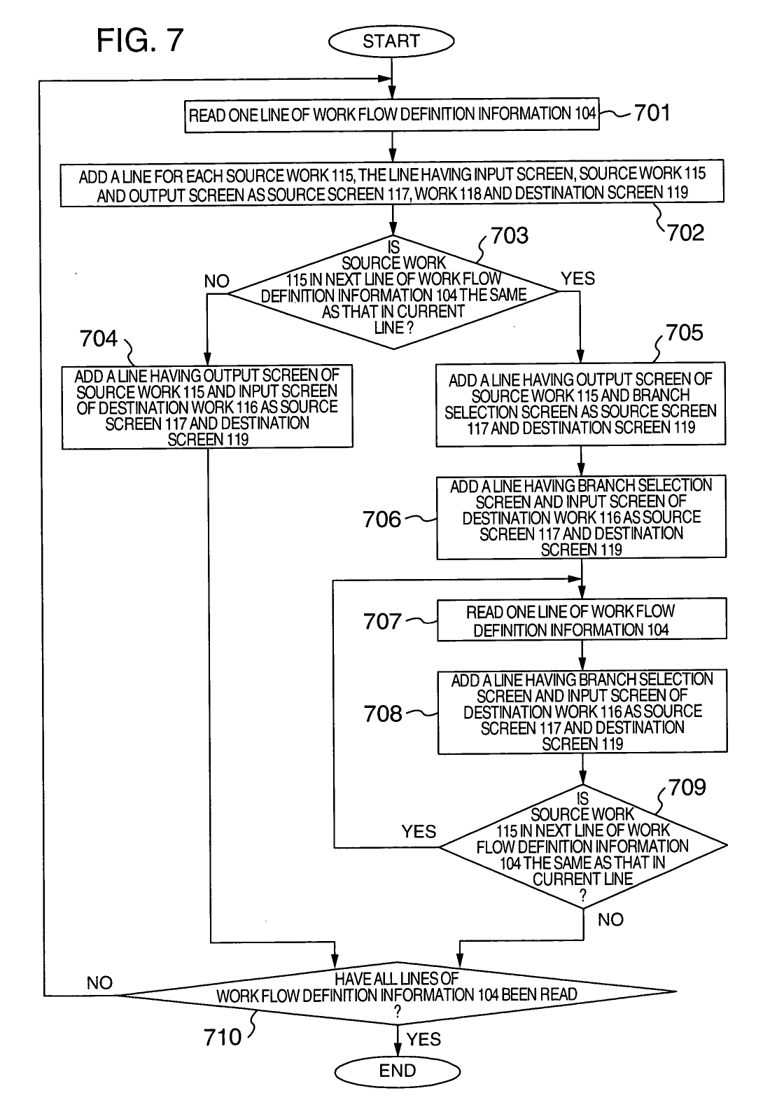

Next, the flow in which the screen flow creation procedure 105 creates the screen flow definition information 106 will be described with reference to FIG. 7.

(Step 701) One line of the work flow definition information 104 is read. For example, in the case of the work flow definition information 104 in FIG. 5, “price search” in the source work 115 and “similar search” in the destination work 116 are read.

(Step 702) For each source work 115, a line having an input screen, a work and an output screen correspondingly to the source screen 117, the work 118 and the destination screen 119 respectively is added to the screen flow definition information 106. For example, in the case of the work flow definition information 104 and the screen flow definition information 106 in FIG. 5, a line having “price search input screen”, “price search” and “price search output screen” correspondingly to the source screen 117, the work 118 and the destination screen 119 respectively is added.

(Step 703) In order to judge whether there is a branch or not, it is judged whether the name of the source work 115 in the next line of the work flow definition information 104 is the same as the name of the source work 115 in the line being read currently or not. When the former is not the same as the latter, the processing advances to Step 704. When the former is the same as the latter, the processing jumps to Step 705. For example, in the case of the work flow definition information 104 in FIG. 5, the source work 115 in the next line is also “price search”, which is the same as the name of the source work 115 in the line being read currently. Thus, the processing jumps to Step 705.

(Step 704) A line having the output screen of the source work 115 and the input screen of the destination work 116 correspondingly to the source screen 117 and the destination screen 119 respectively is added to the screen flow definition information 106.

(Step 705) A line having the output screen of the source work 115 and a branch selection screen correspondingly to the source screen 117 and the destination screen 119 respectively is added to the screen flow definition information 106. For example, in the case of the work flow definition information 104 and the screen flow definition information 106 in FIG. 5, a line having “price search output screen” and “branch selection screen” in the source screen 117 and the destination screen 119 respectively is added.

(Step 706) A line having a branch selection screen and the input screen of the destination work 116 correspondingly to the source screen 117 and the destination screen 119 respectively is added to the screen flow definition information 106. For example, in the case of the work flow definition information 104 and the screen flow definition information 106 in FIG. 5, a line having “branch selection screen” and “similar search input screen” in the source screen 117 and the destination screen 119 respectively is added.

(Step 707) One line of the work flow definition information 104 is read. For example, in the case of the work flow definition information 104 in FIG. 5, “price search” in the source work 115 and “order” in the destination work 116 are read.

(Step 708) A line having a branch selection screen and the input screen of the destination work 116 correspondingly to the source screen 117 and the destination screen 119 respectively is added to the screen flow definition information 106. For example, in the case of the work flow definition information 104 and the screen flow definition information 106 in FIG. 5, a line having “branch selection screen” and “order input screen” in the source screen 117 and the destination screen 119 respectively is added.

(Step 709) In order to judge whether there is another branch or not, it is judged whether the name of the source work 115 in the next line of the work flow definition information 104 is the same as the name of the source work 115 in the line being read currently or not. When the former is not the same as the latter, the processing advances to Step 710. When the former is the same as the latter, the processing returns to Step 707. For example, in the case of the work flow definition information 104 in FIG. 5, there is no source work 115 in the next line. Thus, the processing advances to Step 710.

(Step 710) It is judged whether all the lines of the work flow definition information 104 have been read or not. When they have been read, the processing is terminated. When any one of them has not yet been read, the processing returns to Step 701. For example, in the case of the work flow definition information 104 in FIG. 5, there is no source work 115 in the next line so that the processing is terminated.

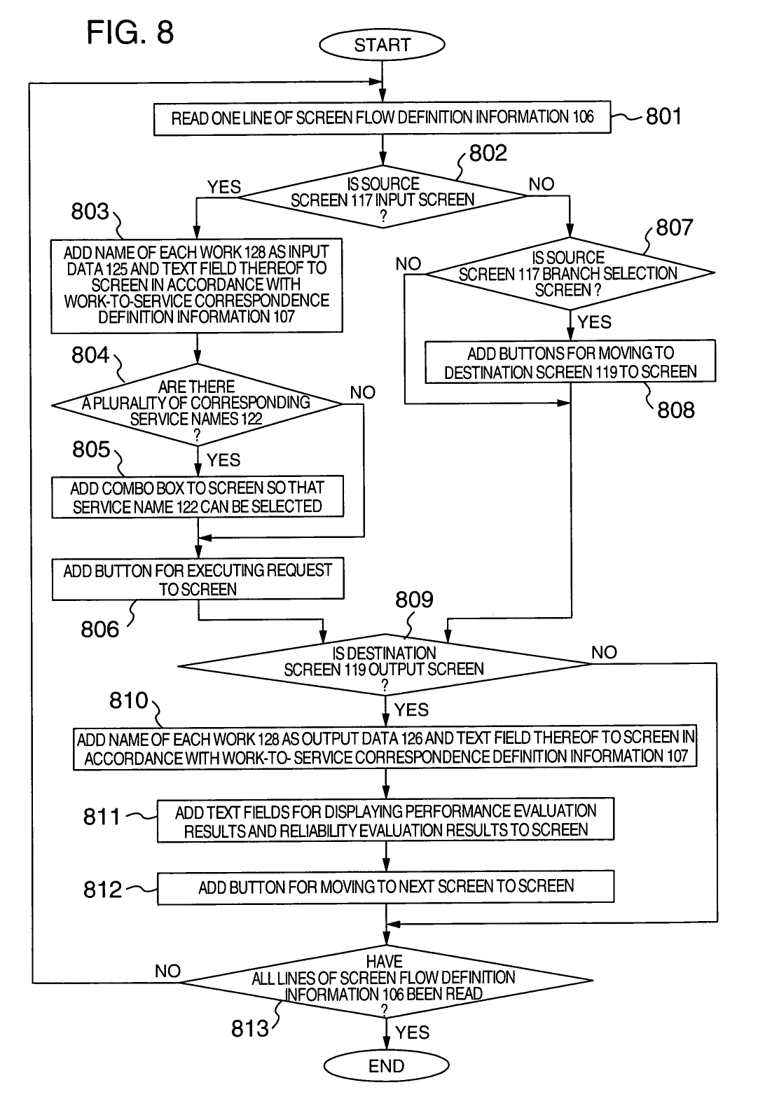

Next, the flow in which the screen creation procedure 108 creates the screen 219 will be described with reference to FIG. 8.

(Step 801) One line of the screen flow definition information 106 is read. For example, in the case of the screen flow definition information 106 in FIG. 5, the line having is “price search input screen”, “price search” and “price search output screen” in the source screen 117, the work 118 and the destination work 119 respectively is read.

(Step 802) It is judged whether the source screen 117 is the input screen 109 or not. When it is the input screen 109, the processing advances to Step 803. When it is not the input screen 109, the processing jumps to Step 807. For example, in the case of the screen flow definition information 106 in FIG. 5, “price search input screen” in the source screen 117 is the input screen 109. Thus, the processing advances to Step 803.

(Step 803) The outline of the input screen 109 is created newly, and the name of the work 128 as the input data 125 and text fields for inputting data are added to the screen on the basis of the work-to-service correspondence definition information 107. For example, in the case of the work-to-service correspondence definition information 107 in FIG. 5 and the input screen 109 in FIG. 6, names of input data such as the maker name 130, the commodity name 131, the unit price 132 and the quantity 133 and text fields for inputting the data are added to the input screen 109 in accordance with the order 129 with the work 128 of the work-to-service correspondence definition information 107 as the input data 125.

(Step 804) It is judged whether there are a plurality of corresponding service names 122 or not. When there are a plurality, the processing advances to Step 805. When there is only one, the processing jumps to Step 806. For example, in the case of the work-to-service correspondence definition information 107 in FIG. 5, there are a plurality of service names 122 in the work-to-service correspondence definition information 107. Thus, the processing advances to Step 805.

(Step 805) A combo box through which a service name 122 can be selected is added to the screen. For example, in the case of the work-to-service correspondence definition information 107 in FIG. 5 and the input screen 109 in FIG. 6, a combo box for selecting a service such as the service 134 is added.

(Step 806) A button for executing a request is added to the screen. One screen is created through Steps 803 to 806. For example, in the case of the input screen in FIG. 6, the OK button 135 is added.

(Step 807) It is judged whether the source screen 117 is the branch selection screen 217 or not. When it is the branch selection screen 217, the processing advances to Step 808. When it is not the branch selection screen 217, the processing jumps to Step 809. For example, in the case of the screen flow definition information 106 in FIG. 5, “price search input screen” in the source screen 117 is the input screen 109. Thus, the processing jumps to Step 809.

(Step 808) The outline of the branch selection screen 223 is created newly if not, and buttons for moving to the destination screen 119 is added to the screen. Incidentally, when any subsequent line has the same source screen 117, the buttons are added to the branch selection screen 223 having already been created. For example, in the case of the branch selection screen 223 in FIG. 6, buttons such as the similar search 601 and the order 602 are added.

(Step 809) It is judged whether the destination screen 119 is the output screen 110 or not. When it is the output screen 110, the processing advances to Step 810. When it is not the output screen 110, the processing jumps to Step 813. For example, in the case of the screen flow definition information 106 in FIG. 5, “price search output screen” in the destination screen 119 is the output screen 110. Thus, the processing advances to Step 810.

(Step 810) The outline of the output screen 110 is created newly, and the names of the work 128 as the output data 126 and text fields for outputting the data are added to the screen on the basis of the work-to-service correspondence definition information 107. For example, in the case of the work-to-service correspondence definition information 107 in FIG. 5 and the output screen 110 in FIG. 6, names of output data such as the price 136 and the shop name 137 and text fields for displaying the data are added to the output screen 110 in accordance with the order 129 with the work 128 of the work-to-service correspondence definition information 107 as the output data 126.

(Step 811) Text fields for displaying the performance evaluation result and the reliability evaluation result are added to the screen. For example, in the case of the output screen 110 in FIG. 6, names of the performance (unit average) 138 and the performance (total average) 139 for displaying the performance result, names of the reliability (unit average) 140 and the reliability (total average) 141 for displaying the reliability, and text fields for displaying the data thereof are added.

(Step 812) A button for moving to the next screen is added to the screen. One screen is created through Steps 810 to 812. For example, in the case of the output screen 110 in FIG. 6, the OK button 142 is added.

(Step 813) It is judged whether all the lines of the screen flow definition information 106 have been read or not. When they have been read, the processing is terminated. When any one of them has not yet been read, the processing returns to Step 801. For example, in the case of the screen flow definition information 106 in FIG. 5, there is a subsequent line. Thus, the processing returns to Step 801.

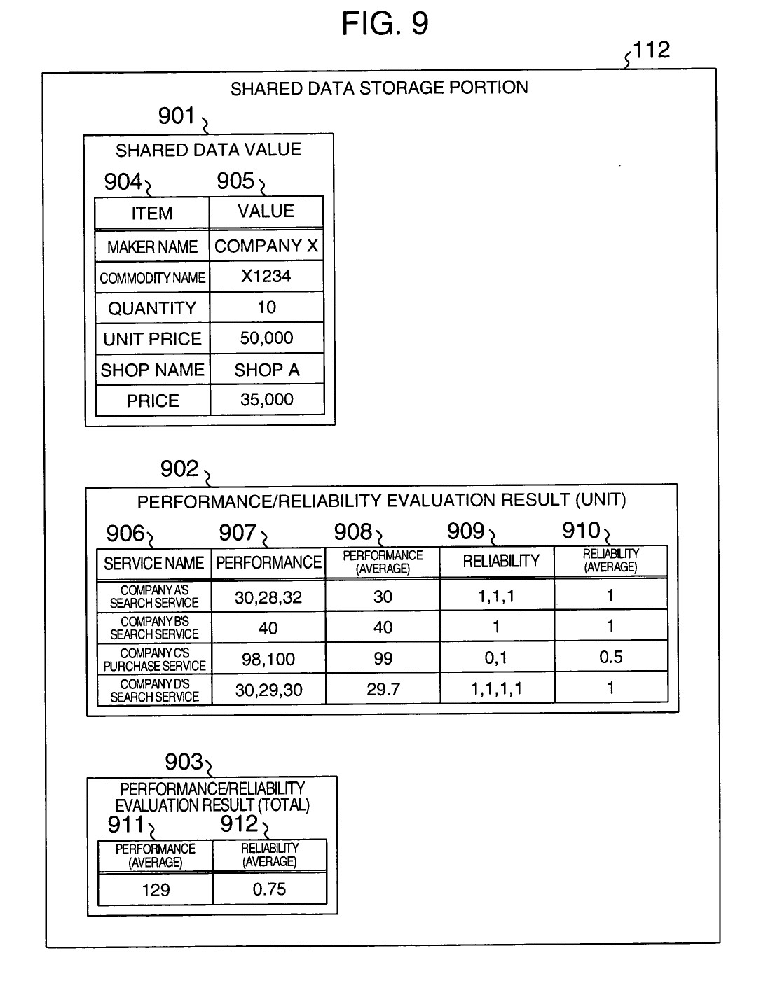

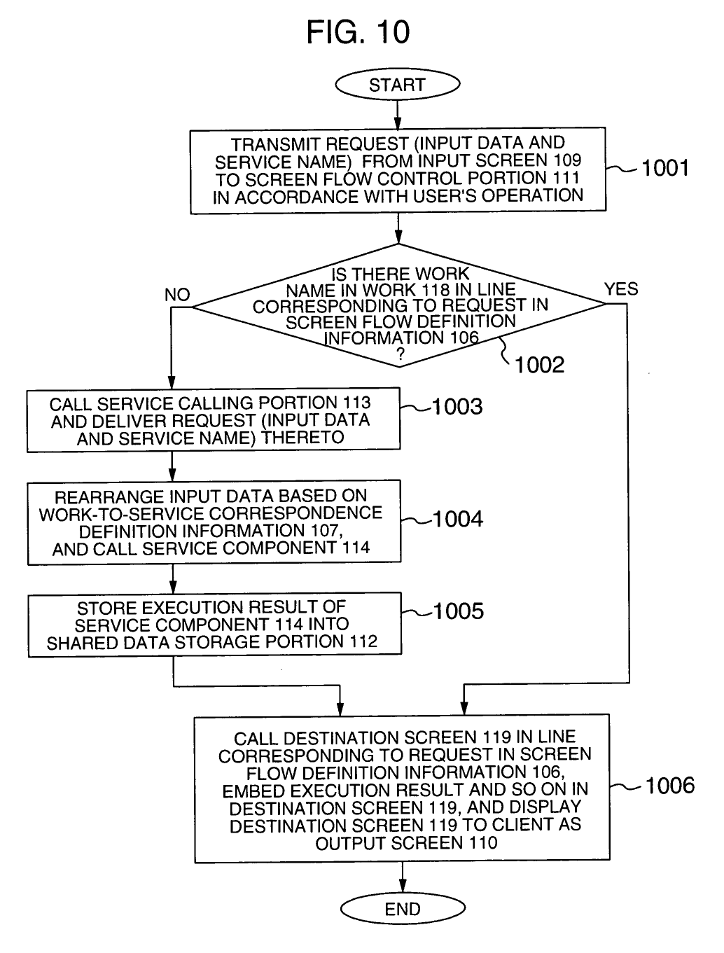

Next, the details of the runtime environment will be described with reference to FIGS. 9 and 10.

FIG. 9 shows the details of data to be stored by the shared data storage portion 112. The shared data storage portion 112 is constituted by a shared data value 901 for storing values of shared data, a performance/reliability evaluation result (unit) 902 for storing the performance/reliability evaluation result of each service unit, and a performance/reliability evaluation result (total) 903 for storing the total performance/reliability evaluation result of a combination of service components being evaluated currently. The shared data value 901 is constituted by an item 904 indicating a name of each shared data and a value 905 indicating the value of the shared data. The performance/reliability evaluation result (unit) 902 is constituted by a service name 906 indicating the name of each service, a performance 907 indicating respective measured values of performance obtained by executing the service heretofore, a performance (average) 908 indicating the average value of the performance, a reliability 909 indicating respective measured values of reliability, and a reliability (average) 910 indicating the average value of the reliability. The performance/reliability evaluation result (total) 903 is constituted by a performance (average) 911 indicating the average value of total performance of a combination of service components, and a reliability (average) 912 indicating the average value of reliability thereof.

Next, the flow of processing of the runtime environment will be described with reference to FIG. 10. The processing shown in FIG. 10 is executed chiefly in the screen flow control portion 111.

(Step 1001) In accordance with user's operation, a request is transmitted to the screen flow control portion 111 through a screen displayed to the client. When the displayed screen is the input screen 109, assume that the request includes the values of input data and the name of a service to be executed. For example, in the case of the input screen 109 in FIG. 6, input data such as the maker name 130, the commodity name 131, the unit price 132 and the quantity 133 and the name of a service selected through a combo box of the service 134 such as company A's search service (price search) are transmitted as request contents.

(Step 1002) The screen flow control portion 111 reads a corresponding line from the screen flow definition information 106, and judges whether the line includes the name of a work in the work 118 or not. When it includes the name of a work, the processing advances to Step 1003. When it does not include the name of any work, the processing jumps to Step 1006. For example, in the case of the screen flow definition information 106 in FIG. 5, the source screen 117 is “price search input screen”, the work 118 is “price search” and the destination screen 119 is “price search output screen”. Thus, the processing advances to Step 1003 because the work 118 has the name of a work.

(Step 1003) The screen flow control portion 111 calls the service calling portion 113 and delivers thereto the request contents such as the values of input data and the name of a service to be executed. For example, in the case of the input screen 109 in FIG. 6, the input data such as the maker name 130, the commodity name 131, the unit price 132 and the quantity 133 and the name of a service such as company A's search service (price search) are contained in the input screen 109 as the request contents and delivered directly to the service calling portion 113.

(Step 1004) The service calling portion 113 rearranges the input data on the basis of the work-to-service correspondence definition information 107 and calls the service component 114. For example, in the case of the work-to-service correspondence definition information 107 in FIG. 5, “company A's search service” is selected as the service name 122. Thus, the input data is rearranged in accordance with the correspondence of the service 127 to the work 128. After that, “company A's search service” is called, and the operation “price search” is executed.

(Step 1005) The service calling portion 113 receives the execution result from the service component 114 and stores the result into the shared data storage portion 112. For example, in the case of the work-to-service correspondence definition information 107 in FIG. 5, the output data of “shop name” and “selling price” are obtained as the execution result from the service component. The output data is rearranged in accordance with the correspondence of the service 127 to the work 128. After that, “price” and “shop name” are stored in the shared data storage portion 112. For example, in FIG. 9, the values of “price” and “shop name” are stored in the value 905. In addition, the performance and reliability of the service alone are measured, and their average values or the like are calculated to obtain the performance 907, the performance (average) 908, the reliability 909 and the reliability (average) 910 and update the performance (average) 911 and the reliability (average) 912.

(Step 1006) The screen flow control portion 111 reads a corresponding line from the screen flow definition information 106, and displays the destination screen 119 on the screen of the client. In the case where the destination screen 119 is the output screen 110, the screen is displayed after the execution results or the performance/reliability evaluation results are embedded therein. For example, in the case of the screen flow definition information 106 in FIG. 5 and the output screen 110 in FIG. 6, the source screen 117 is “price search input screen”, the work 118 is “price search” and the destination screen 119 is “price search output screen”. Thus, the “price search output screen” is displayed. Since the “price search output screen” is the output screen 110, the screen is displayed after the execution results are embedded into the price 136, the shop name 137 and so on respectively.

When screens and screen flow definition information are created in the accordance with a work flow, a combination of service components can be confirmed through a dialogue. In addition, confirmation of specifications of existing service components and verification thereof are carried out in the upstream step, critical redo in a downstream step or occurrence of a problem can be prevented.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for supporting a combination of programs using a computer, comprising the steps of:
making said computer read from a storage unit kinds of screens in a source of each work and in a destination of said work and setting of a display flow of said screens in work flow definition information indicating a flow among works, and store screen flow definition information into said storage unit in accordance with said read setting;
in accordance with said screen flow definition information and work-to-service correspondence definition information stored in said storage unit in advance and indicating correspondence of each work to a program providing each service used in said work, creating an input/output screen for executing a program providing said service corresponding to each work; and
outputting an execution result of said program providing said service using said input/output screen in accordance with said screen flow definition information and said work-to-service correspondence definition information.

2. A program development support method, comprising the steps of:
setting kinds of screens in a source of each work and in a destination of said work and a display flow of said screens in work flow definition information indicating a flow among works, to thereby create screen flow definition information;
in accordance with said screen flow definition information and work-to-service correspondence definition information indicating correspondence of each work to each service component, creating an input/output screen for executing said service component corresponding to each work; and
calling said service component and outputting an execution result thereof using said input/output screen in an order following said screen flow definition information and in accordance with said work-to-service correspondence definition information.

3. A program development support method according to claim 2, processing for creating said screen flow definition information including the steps of:
reading each line of said work flow definition information, and adding each line to said screen flow definition information for each source work, said added line having an input screen of a source work, said source work and an output screen of said source work correspondingly to a source screen, a work and a destination screen respectively;
adding a line having an output screen of a source work and a branch selection screen as said source screen and said destination screen respectively and a line having a branch selection screen and an input screen of said destination work as said source screen and said destination screen when a source work in a next line of said work flow definition information is the same as that in said current line; and
adding a line having an output screen of a source work and an input screen of a destination screen as said source screen and said destination screen to thereby create said screen flow definition information when said source work in said next line of said work flow definition information is not the same as that in said current line.

4. A program development support method according to claim 2, processing for creating said input/output screen including the steps of:
reading each line of said screen flow definition information;
when said source screen is an input screen, adding names of input data and text fields thereof to said input screen in accordance with said work-to-service correspondence definition information;
when there are a plurality of corresponding service components, adding a combo box and a button to said screen, said combo box being provided for selecting a service component name, said button being provided for executing a request;
when said source screen is a branch selection screen, adding buttons to said screen, said buttons being provided for moving to said destination screen; and
when said destination screen is an output screen, adding names of output data and text fields thereof to said output screen, adding text fields for displaying performance evaluation results or reliability evaluation results to said screen, and adding a button to said screen for moving to a next screen, in accordance with said work-to-service correspondence definition information.

5. A program development support method according to claim 2, processing for verifying a combination of said service components including the steps of:
allowing a user to transmit a request including input data and a service name to a screen flow control portion through an input screen;
making said screen flow control portion read a line from said screen flow definition information correspondingly to said input screen from which said request is transmitted, judge whether there is a work in said line or not, and call a service calling portion when there is a work;
receiving said request, making said service calling portion call a service component, and storing an execution result of said service component into a shared data storage portion; and
making said screen flow control portion call a destination screen from said screen flow definition information, embed information including said execution result into said destination screen, and display said destination screen to said user.

6. A program development support method according to claim 2, wherein:
said service component is called through a network.

7. A program development support apparatus for supporting a user to verify a combination of service components used to execute works by use of a dialogue type system through a screen, comprising:
means for receiving work flow definition information indicating a flow among works, and creating screen flow definition information;
means for receiving said screen flow definition information and work-to-service correspondence definition information indicating correspondence of said works to said service components, and creating an input/output screen for executing a service component corresponding to each work; and
means for verifying a combination of said service components by use of said work-to-service correspondence definition information, said created screen flow definition information and said input/output screen.

8. A computer-readable storage medium storing a program for executing a method for supporting a user to select a program for providing a service, comprising the steps of:
reading from a storage unit kinds of screens in a source of each work and in a destination of said work and setting of a display flow of said screens in work flow definition information indicating a flow among works, and creating screen flow definition information in accordance with said read kinds of screens and said read setting of said display flow of said screens;
in accordance with said screen flow definition information and work-to-service correspondence definition information stored in said storage unit in advance and indicating correspondence of each work to a program providing a service used in said work, creating an input/output screen to be used for executing said program providing said service corresponding to each work; and
outputting an execution result of said program providing said service using said input/output screen in accordance with said screen flow definition information and said work-to-service correspondence definition information.
